(19) United States
(12) Patent Application Publication
(10) Pub. No.: US 2016/0006149 A1
(43) Pub. Date: Jan. 7, 2016

(54) LOOPED SOCKET PIN

(71) Applicant: QUALCOMM Incorporated, San Diego, CA (US)

(72) Inventors: Siamak FAZELPOUR, San Diego, CA (US); Jiantao ZHENG, San Diego, CA (US); Med NARIMAN, Ladera Ranch, CA (US)

(21) Appl. No.: 14/324,067

(22) Filed: Jul. 3, 2014

(51) Int. Cl. H01R 12/57; H01R 43/00; H01R 43/16; H01R 12/52

(52) U.S. Cl. CPC H01R 12/57; H01R 12/52; H01R 43/007; H01R 43/16

(57) ABSTRACT

Methods and apparatuses, wherein the method includes creating a surface mount socket pin for integrated circuit packaging. The method couples a first conductive element to a second conductive element, wherein the closed loop conductor is configured to provide two paths between the first conductive element and second conductive element, wherein a central region of the closed loop conductor is configured to engage with a plurality of symmetrical bumps in a mold to secure the closed loop conductor, wherein the closed loop conductor is elastic.

### BACKGROUND OF THE INVENTION

1. Field of the Invention

Disclosed embodiments relate to integrated circuit (IC) packaging.

2. Description of the Related Art

A circuit socket is a mechanical component that provides mechanical and electrical connections between a microprocessor package and a printed circuit board (PCB). The socket can allow the circuit to be replaced without soldering.

Common sockets can have retention clips that apply a constant force, which must be overcome when a device is inserted. For chips with a large number of pins, either zero insertion force (ZIF) sockets or land grid array (LGA) sockets may be used instead. These designs can apply a compression force once either a handle (for ZIF type) or a surface plate (LGA type) is put into place.

High speed and high power socketed chips can require a low inductance socket pin to minimize supply voltage droop on socket pins for power delivery and to lower impedance of high speed signals such as high speed memory interface (double data rate) to values closer to 50 ohm. The socket can be the main bottleneck of channel performance. This bottleneck can result in a voltage droop during power delivery, degradation of signal integrity and closure of the eye aperture at the receiver.

FIG. 1 illustrates socket pins, each with one path from a package to a board. A first socket pin 100 is shown with stubs 102 and a single path 104. The path 104 can couple a package 106 and a board 108. A free socket pin 110 is within a first socket 120. A fully deflected socket pin 130 is shown within a second socket 140.

As shown, the socket pin 100, the free socket pin 110, and the fully deflected socket pin 130 have stubs 102, 112, 132. For example, the stubs 102 of the first socket pin 100 can be on the opposite side of the single path 104. Electromagnetic waves can travel back and forth along the stub, which can cause loss. The electricity can reverse direction on the socket pin 100. There can be significant resistance and inductance as the need for power delivery increases.

### SUMMARY

The disclosure is directed to a looped socket pin.

A surface mount socket pin for integrated circuit packaging can comprise a closed loop conductor configured to couple a first conductive element to a second conductive element. The closed loop conductor can be configured to provide two paths between the first conductive element and second conductive element. The central region of the closed loop conductor can be configured to engage with a plurality of symmetrical bumps in a mold to secure the closed loop conductor, and wherein the closed loop conductor is elastic.

A method for creating a surface mount socket pin for integrated circuit (IC) packaging can comprise coupling a first conductive element to a second conductive element. A closed loop conductor can be configured to provide two paths between the first conductive element and second conductive element. A central region of the closed loop conductor can be configured to engage with a plurality of symmetrical bumps in a mold to secure the closed loop conductor, wherein the closed loop conductor is elastic.

An apparatus can comprise a processor configured to create a surface mount socket pin for IC packaging. The apparatus can comprise means for coupling a first conductive element to a second conductive element. The apparatus can comprise means for configuring the closed loop conductor to provide two paths between the first conductive element and second conductive element. The apparatus can comprise means for configuring the central region of the closed loop conductor to engage with a plurality of symmetrical bumps in a mold to secure the closed loop conductor, wherein the closed loop conductor is elastic.

A non-transitory computer-readable storage medium comprising instructions, which, when executed by an apparatus, cause the apparatus to perform operations to create a surface mount socket pin for integrated circuit packaging. The non-transitory computer-readable storage medium comprises a processor configured to create a surface mount socket pin for IC packaging. The non-transitory computer-readable storage medium can comprise logic configured to couple a first conductive element to a second conductive element. The non-transitory computer-readable storage medium can comprise logic configured to configure the closed loop conductor to provide two paths between the first conductive element and second conductive element. The non-transitory computer-readable storage medium can comprise logic configured to configure the central region of the closed loop conductor to engage with a plurality of symmetrical bumps in a mold to secure the closed loop conductor, wherein the closed loop conductor is elastic.

Some advantages may include the ability to lower pin inductance, impedance and remove stub.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a socket pin with one path from a package to a board.

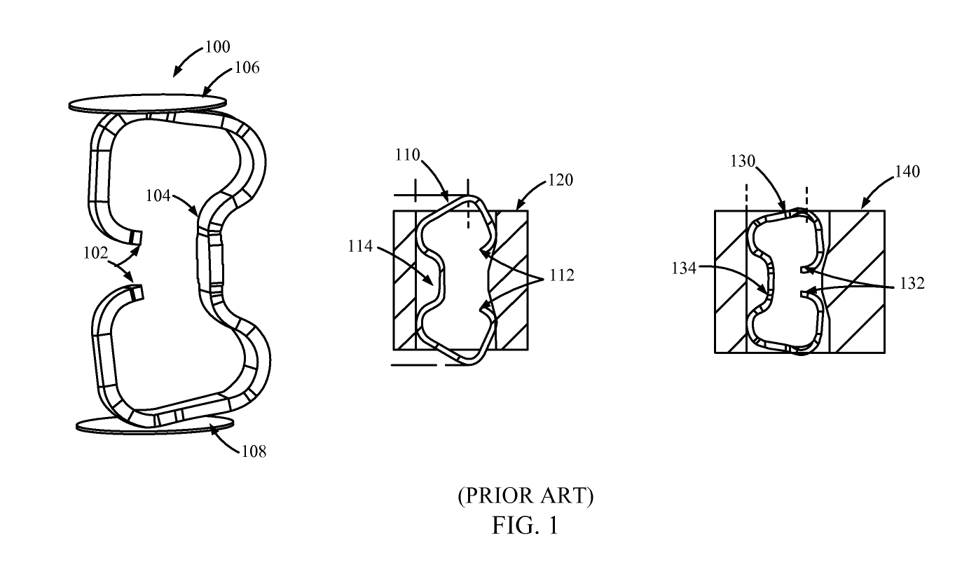

FIG. 2 illustrates a perspective view of a closed loop conductor.

FIG. 3 illustrates deformation on one quarter of a closed loop conductor during insertion of a processor package.

FIG. 4 illustrates a side view of half of a closed loop conductor.

FIG. 5 illustrates a half of a closed loop conductor and its curvature as compared to a mold's curvature.

FIG. 6 illustrates return loss of a prior art socket pin as compared to a closed loop conductor.

FIG. 7 illustrates insertion loss of a prior art socket pin as compared to a closed loop conductor.

FIG. 8 illustrates an operational flow of a method for creating a closed loop conductor.

FIG. 9 is a block diagram showing an exemplary wireless communication system with a closed loop conductor.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

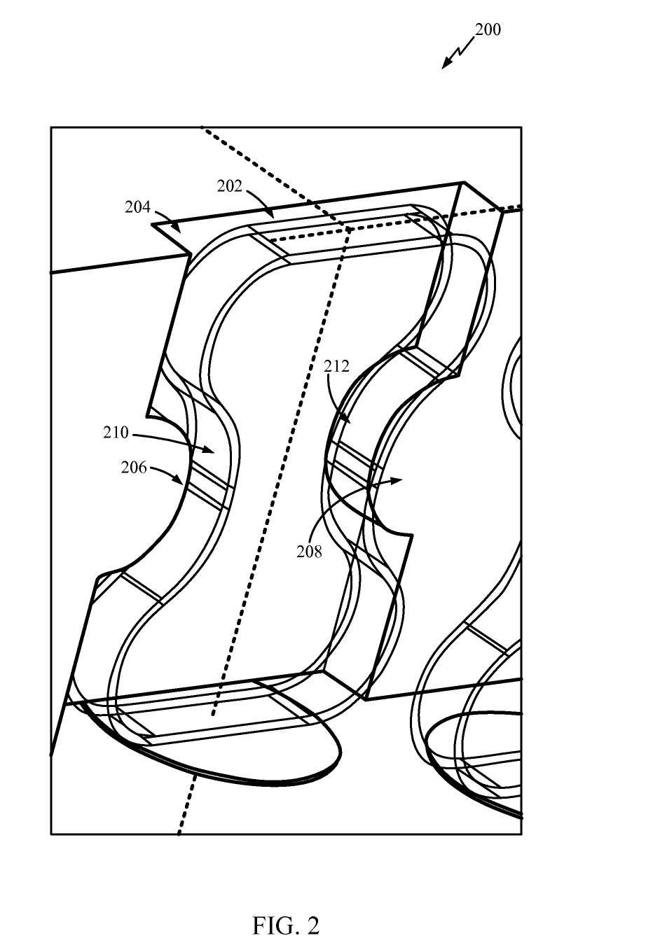

FIG. 2 illustrates a perspective view of a closed loop conductor 202. The closed loop conductor can be inserted to fit a mold 204. The mold can have symmetrical bumps 206, 208. The closed loop conductor 202 has two paths 210, 212, which can allow two paths 210, 212 from a first conductive element to a second conductive element. For example, the first conductive element can be a substrate, and the second conductive element can be a PCB. The two paths can be 180 degrees apart. In some embodiments, a central region of each of the paths 210, 212 is configured to engage with the symmetrical bumps 206, 208 in the mold 204 to secure the closed loop conductor 202. The closed loop conductor 202 may not have a stub forming an opening. As shown, the closed loop conductor 202 can be elastic in order to be coupled and uncoupled with the mold 204 and the symmetrical bumps 206, 208. In some embodiments, beryllium copper can be used for making the closed loop conductor 202. In coupling the closed loop conductor 202 with the symmetrical bumps 206, 208, a force applied to the closed loop conductor may not exceed an elasticity of the closed loop conductor 202. For example, the elasticity of the closed loop conductor can have a threshold for a force applied during coupling. In decoupling the closed loop conductor 202 with the symmetrical bumps 206, 208, a force applied to closed loop conductor may not exceed an elasticity of the closed loop conductor 202. For example, the elasticity of the closed loop conductor can have a threshold for a force applied during decoupling.

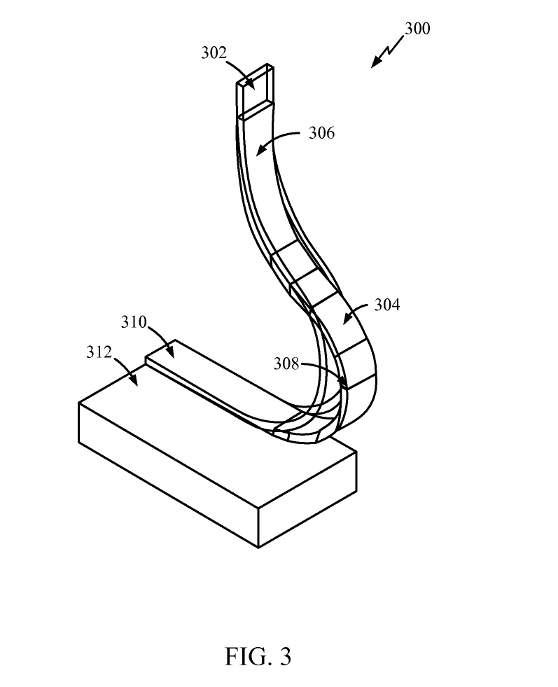

FIG. 3 illustrates deformation on one quarter of a closed loop conductor 300 when an integrated circuit (IC) package is compressed against a mold. An uncompressed closed loop conductor 302 is shown with a compressed closed loop conductor 304 for comparison. In FIG. 3, the compressed closed loop conductor 304 shows different amounts of deformation in a longitudinal direction. For example, the compressed closed loop conductor 304 can have a path 306. The compressed closed loop conductor 304 can have a securing portion 308 to ensure the compressed closed loop conductor 304 remains coupled until the compressed closed loop conductor 304 is decoupled intentionally. The compressed closed loop conductor 304 can have a coupling portion 310 that couples to a conductive element 312.

As shown, the path 306 can have a minimum deformation in comparison to the coupling portion 310 while the path 306 can move towards to 310 under a compression load. The longitudinal deformation of the loop connector can be enabled by the transverse deformation of the securing portion 308. For example, the path 306 may have a deformation of approximately −0.094 mm longitudinally while the securing portion 308 can have a deformation of approximately −0.084 mm to −0.010 mm and the coupling portion 310 can have no deformation. In some embodiments, the path 306 can move towards the conductive element 312 during compression, while the securing portion 308 can move away from the conductive element 312 during compression.

In some embodiments, if 55 gram force is applied, the total deformation can be 190 μm, For example, this deformation can be used to generate a desired mechanical contact between the pin and an integrated circuit device. The geometry of the closed loop conductor 300 can be 180 μm wide with a 20 μm film thickness.

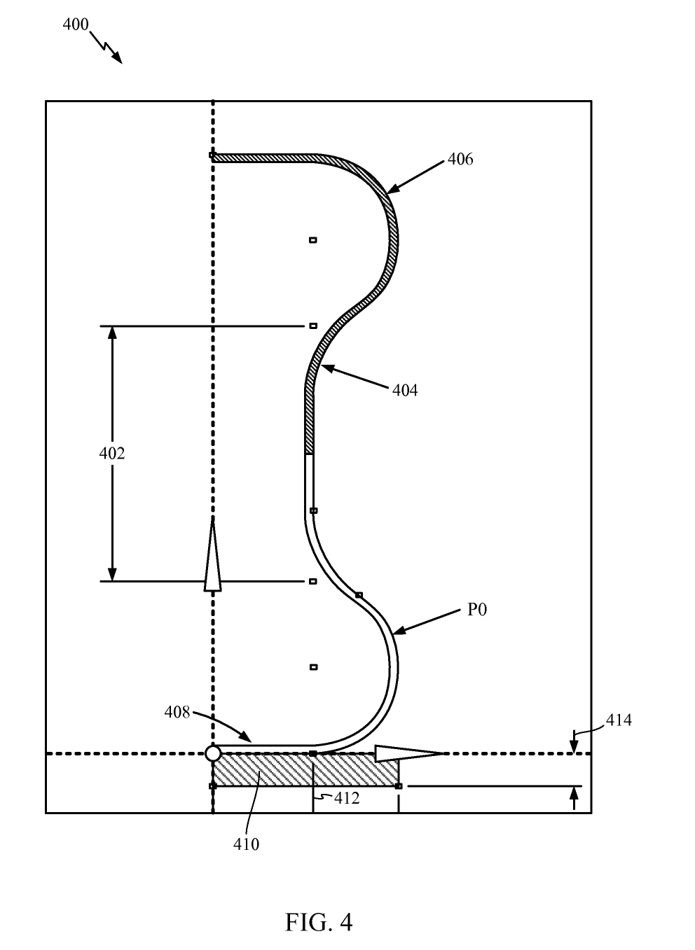

FIG. 4 illustrates a side view of half of a closed loop conductor 400. The closed loop conductor 400 is shown as being 0.270 mm wide, 1.2 mm long, and 1.5 mm tall. The closed loop conductor can have a path 402, a fillet 404 between the path 402 and a securing portion 406, and a coupling portion 408.

In some embodiments, the path 402 can have a height of 0.762 mm. The fillet 404 between the path 402 and the securing portion 406 can have a radius of 0.200 mm. The securing portion 406 can have a radius that is the same as the fillet 404. The securing portion 406 can have 0.254 mm radius. Similarly, the length 410 between the central region of the closed loop conductor 400 to the path can be 0.300 mm The length 412 of the coupling portion can be 0.554 mm The height 414 is shown in FIG. 4. The closed loop conductor 400 can be 30 μm thick. With 55 gram force, the deformation can be 182 μm. In another example, the closed loop conductor 400 can be 25 μm thick. With 55 gram force, the deformation can be 313.8 μm. In some embodiments, the spring dimension can be calculated as follows: 0.180 mm wide by 1.108 mm long by 1.778 mm tall. The spring film thickness can be 30 μm.

In some embodiments, the closed loop conductor 400 can be formed in a process. For example, a casting or a drawing process can make a pipe. For example, molten metal can be poured into a cast to form the closed loop conductor. In a drawing process, molten metal can be stretched using tensile force; to make a pipe for the closed loop conductor, a plugged die can be used to form a hollow portion in the pipe. The pipe with a loop-form x-section can be created. The pipe can be cut to form the looped socket pin. In some embodiments, a mold is created with a bump in the middle; and the closed loop conductor is pressed into the mold once the mold is created.

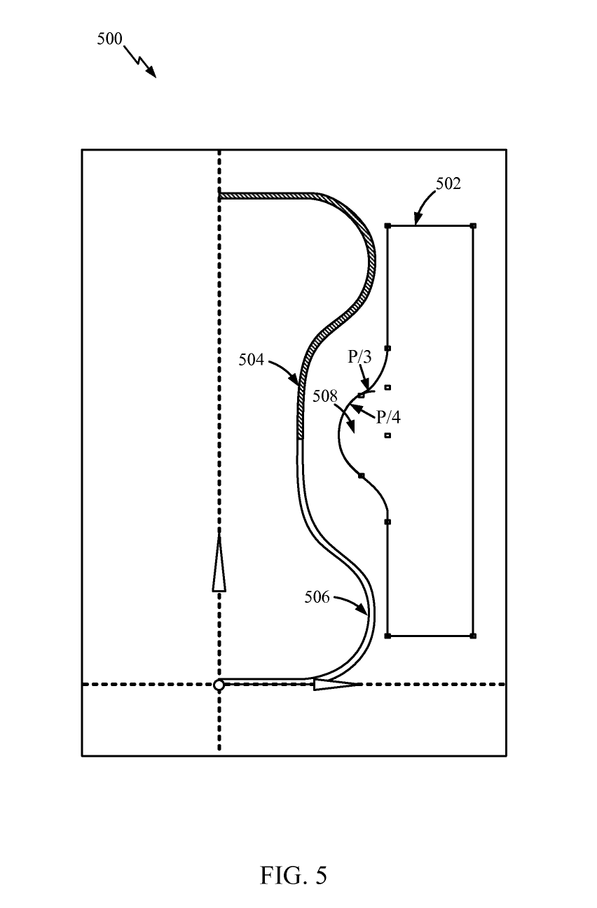

FIG. 5 illustrates a half of a closed loop conductor 500 and its curvature as compared to a mold's 502 curvature. The closed loop conductor 500 can have a path 504 and a securing portion 506. The mold 502 can have a symmetrical bump 508. The distance between the securing portion 506 and the mold 502 can be 100 μm. The distance between the path 504 and the symmetrical bump 508 can be approximately 200 μm. The radius of the symmetrical bump 508 can be 200 μm. The mold 502 can be 1.5 mm thick.

In some embodiments, the closed loop conductor 500 has a narrower width in the central region than outer regions of the closed loop conductor 500. In some embodiments, the symmetrical bumps have a circular shape that has a smaller diameter than a length of the central region of the closed loop conductor.

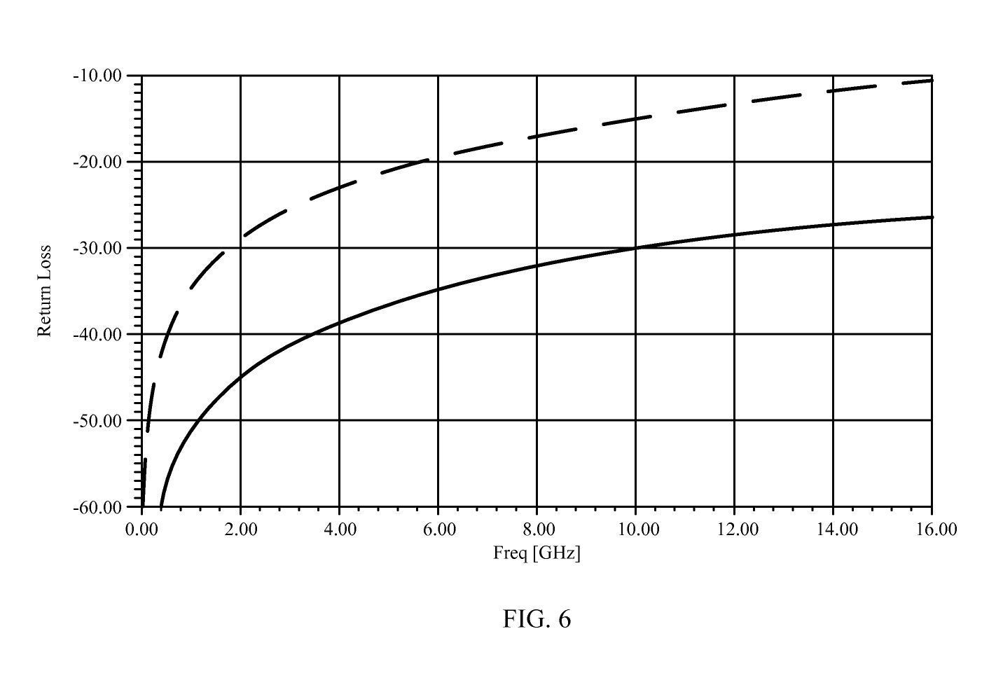

FIG. 6 illustrates return loss of a prior art socket pin as compared to a closed loop conductor. The prior art socket pin is represented by a dashed line, while the closed loop conductor is represented by a solid line. As shown, the return loss in a prior art socket pin increases as the frequency increases significantly more than the closed loop conductor. In some embodiments, the closed loop conductor can be formed without stubs, which can account for less insertion loss than the prior art. For example, the prior art socket pin can have a return loss of −21.2505 dB at a frequency of 5.00 GHz while the closed loop conductor can have a return loss of −36.6959 dB at the same frequency.

As shown in Table 1, when the closed loop conductor 202 of FIG. 2 is compared to the prior art socket pin 100 of FIG. 2, return loss can be reduced. Table 2 provides exemplary data wherein the second conductive path of the closed loop conductor 202 reduces inductance by 31%. Likewise, according to Table 2, resistance can be reduced by 50% from the prior art socket pin 100.

TABLE 1

Frequency [GHz]

| | 1.6 | 5 | 8 | 16 |
|---|---|---|---|---|
| Prior Art Socket Pin [dB] | −31.0 | −21.3 | −17.1 | −10.6 |
| Closed loop conductor [dB] | −47.2 | −36.7 | −32.3 | −26.7 |
| Improvement [dB] | −16.2 | −15.4 | −15.2 | 16.1 |

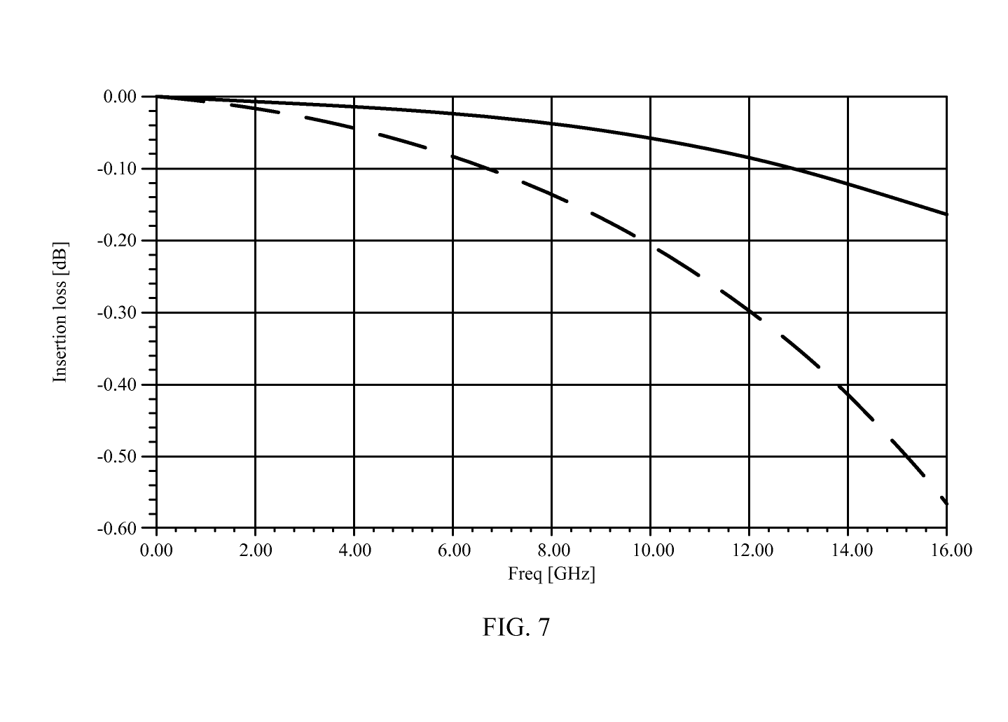

FIG. 7 illustrates insertion loss of a prior art socket pin as compared to a closed loop conductor. The prior art socket pin is represented by a dashed line, while the closed loop conductor is represented by a solid line. As shown, the insertion loss in a prior art socket pin increases as the frequency increases significantly more than the closed loop conductor. In some embodiments, the closed loop conductor can be formed without stubs, which can account for less insertion loss than the prior art. For example, the prior art socket pin can have an insertion loss of approximately −0.20 dB at a frequency of 10 GHz while the closed loop conductor can have a return loss of approximately −0.06 dB at the same frequency.

As shown in Table 2, when the closed loop conductor 202 of FIG. 2 is compared to the prior art socket pin 100 of FIG. 2, inductance can be reduced. Table 2 provides exemplary data wherein the second conductive path of the closed loop conductor 202 improves inductance by 31%. Likewise, according to Table 2, resistance can be reduced by 50% from the prior art socket pin 100.

TABLE 2

| | Frequency at 100 MHz | | |
|---|---|---|---|
| | Resistance in | Inductance | Inductance |
| # of conductive paths | milliohms | (L) [pH] | reduction |
| Prior Art Socket Pin - 1 | 18 | 872 | Baseline |
| Closed loop conductor - 2 | 9 | 605 | 31% |

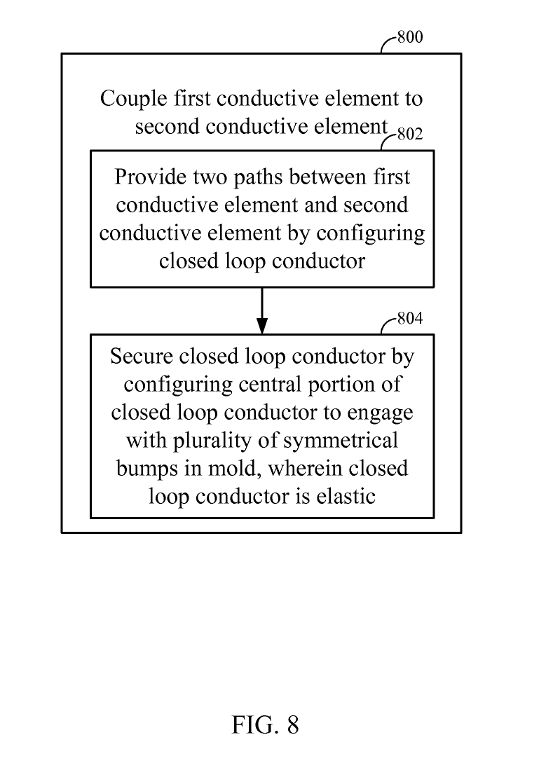

FIG. 8 illustrates an operational flow for creating a closed loop conductor that can include a method comprising: coupling a first conductive element to a second conductive element (e.g., wherein the first conductive element is a substrate and the second conductive element is a PCB)—Block 800. The coupling block 800 can further comprise: providing two paths between the first conductive element and second conductive element by configuring a closed loop conductor (e.g., wherein the conductor is configured without a stub forming an opening; wherein the closed loop conductor has a narrower width in the central region than outer regions of the closed loop conductor, wherein the plurality of symmetrical bumps have a circular shape that has a smaller diameter than a length of the central region of the closed loop conductor)—Block 802; and securing the closed loop conductor by configuring a central region of the closed loop conductor to engage with a plurality of symmetrical bumps in a mold, wherein the closed loop conductor is elastic—Block 804.

In some embodiments, the method for creating the surface mount socket pin for IC packaging can further comprise creating a cast and pouring molten metal into the cast. In some embodiments, the method for creating the surface mount socket pin for IC packaging can further comprise creating a pipe with a loop-form and cutting the pipe. In some embodiments, the method for creating the surface mount socket pin for IC packaging can further comprise creating a mold with a bump in the middle and pressing the closed loop conductor into the mold once the mold is created. In some embodiments, the method for creating the surface mount socket pin for IC packaging can further comprise coupling the closed loop conductor with the plurality of symmetrical bumps, wherein a force applied during the coupling does not exceed an elasticity of the closed loop conductor. Similarly, in some embodiments, the method for creating the surface mount socket pin for IC packaging can further comprise decoupling the closed loop conductor with the plurality of symmetrical bumps, wherein a force applied during the decoupling does not exceed an elasticity of the closed loop conductor.

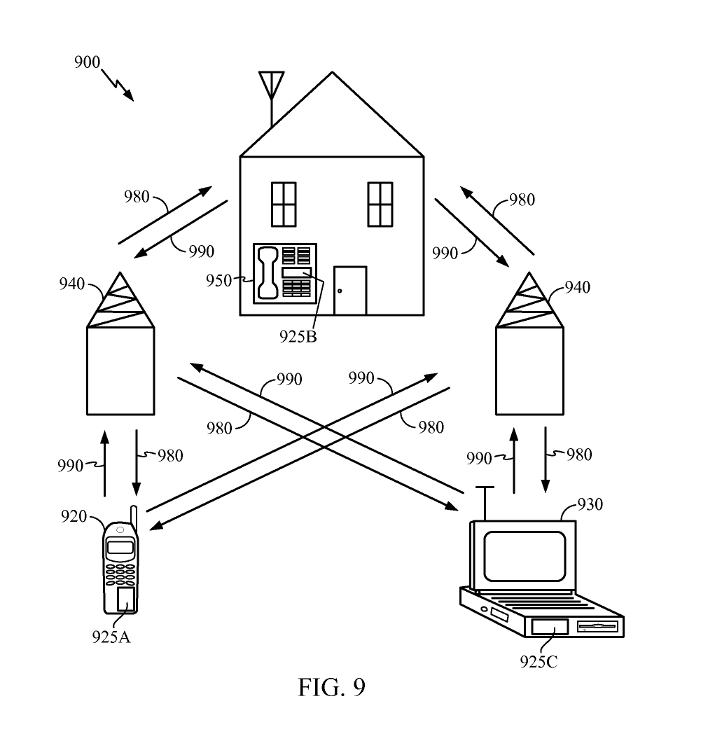

FIG. 9 is a block diagram showing an exemplary wireless communication system 900 in which an embodiment of the disclosure may be advantageously employed. For purposes of illustration, FIG. 9 shows three remote units 920, 930, and 950 and two base stations 940. It will be recognized that wireless communication systems may have many more remote units and base stations. Remote units 920, 930, and 950 include IC devices 925A, 925B and 925C, as disclosed below. It will be recognized that any device containing an IC may also include a closed loop conductor apparatus having the disclosed features and/or components manufactured by the processes disclosed here, including the base stations, switching devices, and network equipment. FIG. 9 shows forward link signals 980 from the base station 940 to the remote units 920, 930, and 950 and reverse link signals 990 from the remote units 920, 930, and 950 to base stations 940.

In FIG. 9, the remote unit 920 is shown as a mobile telephone, the remote unit 930 is shown as a portable computer, and the remote unit 950 is shown as a fixed location remote unit in a wireless local loop system. For example, the remote units may be a device such as a music player, a video player, an entertainment unit, a navigation device, a communications device, a personal digital assistant (PDA), a fixed location data unit, and a computer. Although FIG. 9 illustrates remote units according to the teachings of the disclosure, the disclosure is not limited to these exemplary illustrated units. The disclosure may be suitably employed in any device which includes a closed loop conductor apparatus, as described above.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic object. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A surface mount socket pin for integrated circuit packaging comprising:
a closed loop conductor configured to couple a first conductive element to a second conductive element:
wherein the closed loop conductor is configured to provide two paths between the first conductive element and second conductive element,
wherein a central region of the closed loop conductor is configured to engage with a plurality of symmetrical bumps in a mold to secure the closed loop conductor, and
wherein the closed loop conductor is elastic.

2. The surface mount socket pin of claim 1, wherein the first conductive element is a substrate and the second conductive element is a printed circuit board (PCB).

3. The surface mount socket pin of claim 1, wherein the closed loop conductor does not have a stub forming an opening.

4. The surface mount socket pin of claim 1, wherein the closed loop conductor is comprised of a pipe with a loop-form x-section.

5. The surface mount socket pin of claim 4, wherein the pipe is approximately the same diameter as a cast for forming the pipe.

6. The surface mount socket pin of claim 4, wherein a hollow portion of the pipe is approximately the same diameter as a plugged die for forming the pipe.

7. The surface mount socket pin of claim 1, wherein elasticity of the closed loop conductor exceeds a threshold for a force for coupling the closed loop conductor with the plurality of symmetrical bumps.

8. The surface mount socket pin of claim 1, wherein elasticity of the closed loop conductor exceeds a threshold for a force for decoupling the closed loop conductor with the plurality of symmetrical bumps.

9. The surface mount socket pin of claim 1, wherein the closed loop conductor has a narrower width in the central region than outer regions of the closed loop conductor.

10. The surface mount socket pin of claim 9, wherein the plurality of symmetrical bumps have a circular shape that has a smaller diameter than a length of the central region of the closed loop conductor.

11. A method for creating a surface mount socket pin for integrated circuit (IC) packaging, the method comprising:
coupling a first conductive element to a second conductive element, further comprising:
providing two paths between the first conductive element and second conductive element by configuring a closed loop conductor, and
securing the closed loop conductor by configuring a central region of the closed loop conductor to engage with a plurality of symmetrical bumps in a mold, wherein the closed loop conductor is elastic.

12. The method of claim 11, further comprising forming a pipe with a loop-form x-section to form the closed loop conductor.

13. The method of claim 12, further comprising creating a cast to form the pipe and pouring molten metal into the cast.

14. The method of claim 12, further comprising forming a hollow shape for the pipe with a drawing process using a plugged die.

15. The method of claim 11, wherein the first conductive element is a substrate and the second conductive element is a PCB.

16. The method of claim 11, further comprising forming the closed loop conductor without a stub forming an opening.

17. The method of claim 11, further comprising coupling the closed loop conductor with the plurality of symmetrical bumps, wherein a threshold for force applied during the coupling does not exceed an elasticity of the closed loop conductor.

18. The method of claim 11, further comprising decoupling the closed loop conductor with the plurality of symmetrical bumps, wherein a threshold for force of the decoupling does not exceed an elasticity of the closed loop conductor.

19. The method of claim 11, wherein the closed loop conductor has a narrower width in the central region than outer regions of the closed loop conductor.

20. The method of claim 19, wherein the plurality of symmetrical bumps have a circular shape that has a smaller diameter than a length of the central region of the closed loop conductor.

21. An apparatus comprising:
a processor configured to create a surface mount socket pin for IC packaging; and
means for coupling a first conductive element to a second conductive element, further comprising:
means for configuring a closed loop conductor to provide two paths between the first conductive element and second conductive element, and
means for configuring a central region of the closed loop conductor to engage with a plurality of symmetrical bumps in a mold to secure the closed loop conductor, wherein the closed loop conductor is elastic.

22. The apparatus of claim 21, further comprising means for forming a pipe with a loop-form x-section to form the closed loop conductor.

23. The apparatus of claim 22, further comprising means for creating a cast to form the pipe and pouring molten metal into the cast.

24. The apparatus of claim 22, further comprising means for forming a hollow shape for the pipe with a drawing process using a plugged die.

25. The apparatus of claim 21, wherein the first conductive element is a substrate and the second conductive element is a printed circuit board (PCB).

26. The apparatus of claim 21, further comprising means for forming the closed loop conductor without a stub forming an opening.

27. The apparatus of claim 21, further comprising means for coupling the closed loop conductor with the plurality of symmetrical bumps, wherein a threshold for force applied during the coupling does not exceed an elasticity of the closed loop conductor.

28. The apparatus of claim 21, wherein the closed loop conductor has a narrower width in the central region than outer regions of the closed loop conductor.

29. The apparatus of claim 28, wherein the plurality of symmetrical bumps have a circular shape that has a smaller diameter than a length of the central region of the closed loop conductor.

30. A non-transitory computer-readable storage medium comprising instructions, which, when executed by an apparatus, cause the apparatus to perform operations to create a surface mount socket pin for integrated circuit packaging, the non-transitory computer-readable storage medium comprising:
a processor configured to create a surface mount socket pin for IC packaging; and
logic configured to couple a first conductive element to a second conductive element, further comprising:
logic configured to configure a closed loop conductor to provide two paths between the first conductive element and second conductive element, and p2 logic configured to configure a central region of the closed loop conductor to engage with a plurality of symmetrical bumps in a mold to secure the closed loop conductor, wherein the closed loop conductor is elastic.
